(19) United States
(12) Patent Application Publication
(10) Pub. No.: US 2017/0200242 A1
(43) Pub. Date: Jul. 13, 2017

(54) Location Based Method and System for Enhancing Travelers' Experiences

(71) Applicants: Jing Chen, Plano, TX (US); Pei Li, Plano, TX (US); Tommy R. Li, Plano, TX (US); Kaitlynn Li, Plano, TX (US)

(72) Inventors: Jing Chen, Plano, TX (US); Pei Li, Plano, TX (US); Tommy R. Li, Plano, TX (US); Kaitlynn Li, Plano, TX (US)

(21) Appl. No.: 15/402,201

(22) Filed: Jan. 9, 2017

Related U.S. Application Data
(60) Provisional application No. 62/387,966, filed on Jan. 11, 2016.

(51) Int. Cl. G06Q 50/14; H04L 12/58; H04L 29/08; G06Q 50/00; G06F 17/30

(52) U.S. Cl. CPC G06Q 50/14; G06Q 50/01; G06F 17/30867; H04L 67/10; H04L 51/32

(57) ABSTRACT

A method and system for enhancing travelers' experiences at a location such as a hotel or an airport is provided. Travelers may register at a location in Location Centric Travelers Network (LCTN) over the Internet or any wide-area network, to access the updated travelers' needs and wants, experiences and recommendations related to the location. The LCTN services may enhance the travelers' communications among themselves, and allow the travelers to interact as a group or as knowledgeable individuals with local businesses. As a result, the LCTN services may become an important asset that enables travelers to obtain satisfying stay experiences at the location while traveling.

### PRIORITY

The present application claims priority based upon 35USC section 119 and a provisional application with a Ser. No. of 62/387,966, which was filed on Jan. 11, 2016.

### BACKGROUND OF THE INVENTION

1. Field of the Invention

The present invention relates generally to a network method and system, and more particularly, to location centric network services for enhancing travelers' experiences.

2. Description of Related Art

When traveling, people often spend considerable time at a location such as a hotel, airport, and the like, which is an important hub for their travels. However, a location like a hotel or airport focuses on its own business; it does not provide sufficient network services for travelers to communicate among themselves, and to interact as a group or as individuals with local businesses.

Although people can meet each other virtually via Twitter, Facebook, etc., it is interesting for many people to grow and strengthen social network through face-to-face interactions as well. Due to lack of the communication network services, travelers—special business travelers—cannot effectively interact with each other for business and-/or leisure purposes even if they have time when staying at the same place for a considerable time.

Due to lack of the effective communication network services, travelers are not aware of the interests, needs, experiences or recommendations of the other travelers at the location where they are staying. The local business people, on the other hand, do not know exactly the travelers' needs and wants are at a given time; therefore, they cannot customize their offers to meet the needs, and also to achieve their own business profits at the same time. As a result, travelers cannot leverage the location specific travelers' knowledge as individuals or as a group, and often have to pay high prices, sometime, the worst prices for the products and services purchased.

Without good communication network services, travelers may lose many great opportunities in traveling, such as meeting new friends, having funs or having great deals on services when experiencing the local cultures, foods, etc. Thus, many travelers could not have total satisfying experiences while traveling.

The instant invention results from a methodical attempt to resolve the above problems and issues in travel industry.

### SUMMARY OF THE PRESENT INVENTION

The principle objective of the present embodiment is to provide a method and system that uses communication network services or a platform for enhancing travelers' stay experiences at a location, such as a hotel, or an airport, or the like. This and other useful objectives are achieved by using Location Centric Travelers Network (LCTN) services for travelers to obtain desired traveling experiences. The LCTN services may provide updated interests, needs and wants, experiences or recommendations of the travelers at a location, and may allow the travelers to communicate among themselves, and to interact as a group or as knowledgeable individuals with local businesses. As a result, the LCTN services may become an important asset that enables travelers to obtain satisfying stay experiences at the location while traveling.

The summary is provided to introduce a selection of the concepts in simplified form, and is not intended to identify key features of the claimed subject matter, nor is it intended to be used as an aid in determining the scope of the claimed subject matter.

### BRIEF DESCRIPTION OF DRAWINGS

The disclosed embodiments have other advantages and features that will be more readily apparent from the detailed description, the appended claims and the accompanying figures (or drawings). A brief introduction of the figures is below.

FIG. 1 illustrates one embodiment of a web page that may be presented to a traveler who is registering for Location Centric Travelers Network (LCTN) services.

FIG. 2 illustrates one embodiment of a subscriber's profile, in which the traveler selects a location and provides the timeframe of the visiting and his or her personal information.

FIG. 3 illustrates one embodiment of what's up 130. The location specific information is presented to the traveler after the traveler clicks on what's up 130 navigation tag shown in FIG. 1.

FIG. 4 illustrates one embodiment of recommendations after the traveler clicks on recommendation 131 navigation tag shown in FIG. 1.

FIG. 5 illustrates one embodiment of my actions after the traveler clicks on my actions 133 navigation tag shown in FIG. 1.

FIG. 6 illustrates one embodiment of my experiences & recommendations after the traveler clicks on my experiences & recommendations 134 navigation tag shown in FIG. 1.

FIG. 7 is a flow diagram of one embodiment of a method and system for providing Location Centric Travelers Network services.

FIG. 8 illustrates a block diagram of one embodiment of a method and system for providing Location Centric Travelers Network services.

### DETAILED DESCRIPTION

A hotel, airport or the like is usually a hub for travelers. However, a hotel, airport or the like focuses on its own businesses; it does not provide sufficient network services for travelers to communicate among themselves, or for travelers to interact as a group or as knowledgeable individuals with local businesses. As detailed below, Location Centric Travelers Network (LCTN) services may enable travelers to grow and strengthen social networks through interactions, even face-to-face interactions, among themselves at a location where they stay. In addition, LCTN may also enable travelers to effectively interact with local businesses. As a result, travelers may obtain the needed services or products at good or reasonable prices, and, the local businesses may achieve their profits through increasing sale quantity. This may be a win-win solution for both the travelers and the local businesses.

As used herein, a “location” represents a physical location, such as a hotel, an airport, or the like, in which travelers of the LCTN may patronize or congregate. Each location may be associated with a “virtual location” in the LCTN. LCTN may include one or more locations.

The specific examples described herein represent illustrative instances of such a system, method and apparatus and thus should not be construed as being restrictive in nature.

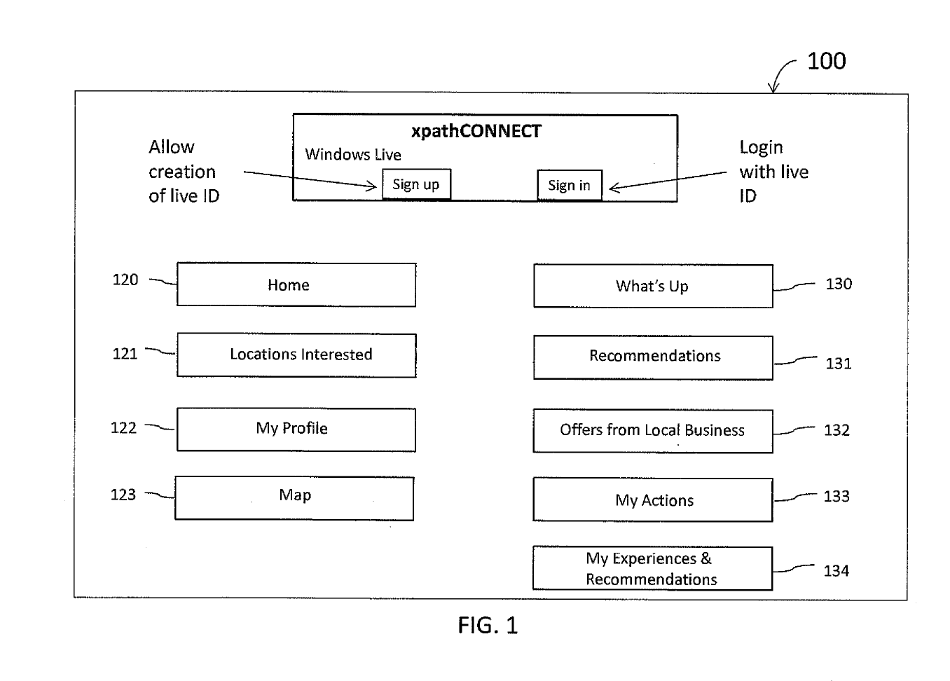

The screen shot 100 shown in FIG. 1 presents a menu bar that includes a series of navigation tags home 120, locations interested 121, my profile 122, map 123, what's up 130, recommendation 131, offers from local business 132, my actions 133, my experiences & recommendations 134. In this example and the others that follow, the LCTN is illustrated as Window Live and is referred to as “xpathCONNECT.” Selection of the navigation tags may bring up items such as locations interested 121 for location selection navigation, what's up 130 that provides the updated activities such as the travelers' interests, needs and wants, etc., at a location.

A traveler may subscribe to the LCTN via various methods. A traveler may respond to a location invitation as a club member of the location, or as a services user of the location such as booking a stay at a hotel, etc. The invitation may be distributed through the LCTN in accordance with the traveler's preferences in distribution channel, such as an email or the like. A traveler may join the LCTN by acquiring the access credential when visiting the location. Alternatively, or in addition, qualified service providers may join the LCTN as special subscribers. In some embodiments, a traveler may join the LCTN by registering a subscriber account granted by the LCTN site administrator. A registration may include a traveler's name, account number (e.g. booking number at a hotel, ticket number of an airline, etc.), and location, etc.

Each location in the LCTN may have its own subscription requirements. A group of similar locations such as the hotels that belong to the same company may use the same subscription requirements. Some locations or group of locations may need subscribers to use their services or as an existing customer who used their services before, whereas other locations may be open to everyone who is interested in the locations.

After a traveler successfully registers a subscriber account, the traveler as a subscriber may navigate LCTN services based on his or her permission.

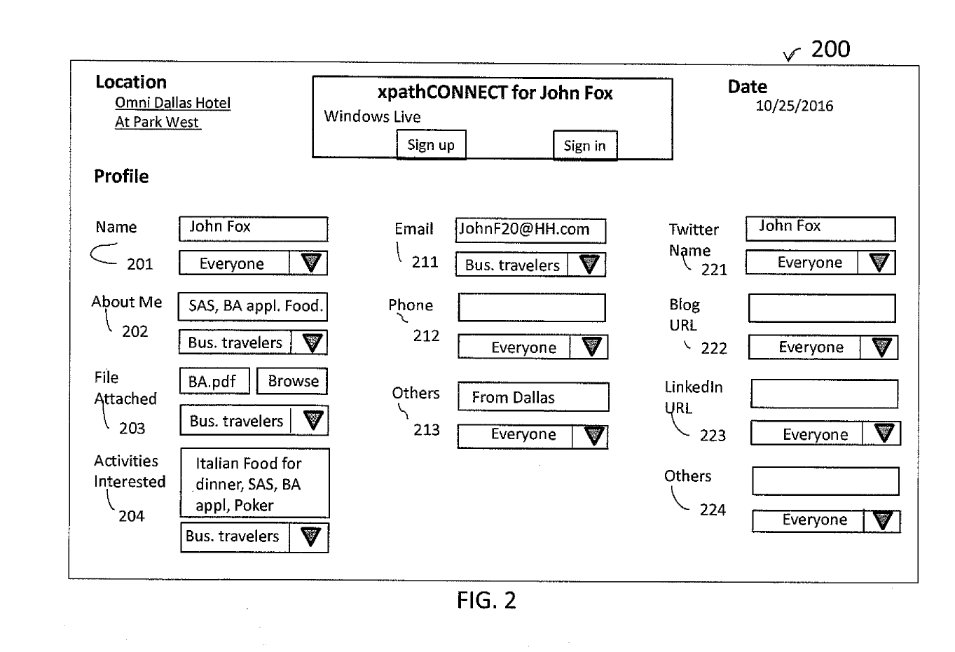

If a traveler selects my profile 122 in FIG. 1, a web page may be presented to allow the traveler to establish his or her own personal profile. An example of such a web page is shown in FIG. 2. The profile may include the traveler's personal facts such as preferred name 201, about me 202, file attached 203 and activities interested 204. The profile may include contact information such as email address 211, phone number 212 and others 213. The profile may also specify the traveler's preferences in social network, such as accounts for Twitter 221, Blog URL 222, LinkedIn URL 223 and Others 224, etc.

The traveler may indicate his or her willingness to share personal information. This helps other travelers and other subscribers to determine if they want to engage with the traveler in chatting, meeting, dining, and other activities at a location. All the subscribers including both travelers and the others may change their permission settings at any time as needed.

In addition, the profile may specify the traveler preferences such as invitation preferences, blocking preferences, search preferences, visibility preferences, and the like. The invitation preferences may determine whether the traveler can be directly contacted by other travelers, or local businesses. The blocking preferences may block certain LCTN subscribers or local businesses from contacting the traveler. For example, a traveler may establish an “ignore” list, which may prevent certain users from contacting him or her. Similarly, a traveler may establish a “friend” list, which may allow unlimited accesses to the traveler's profile, additional messaging options, and the like. The privacy settings may also specify how messages are submitted (broadcast) by the traveler.

The LCTN may allow a traveler to modify or directly apply his or her profile registered for one location to other locations if the traveler meets the registration requirements of the other locations.

LCTN may dynamically present aggregated travelers' general information of a location via other methods such as electronic messaging boards, etc., at the location. This may solicit more travelers to use LCTN services when they are actually present at the location.

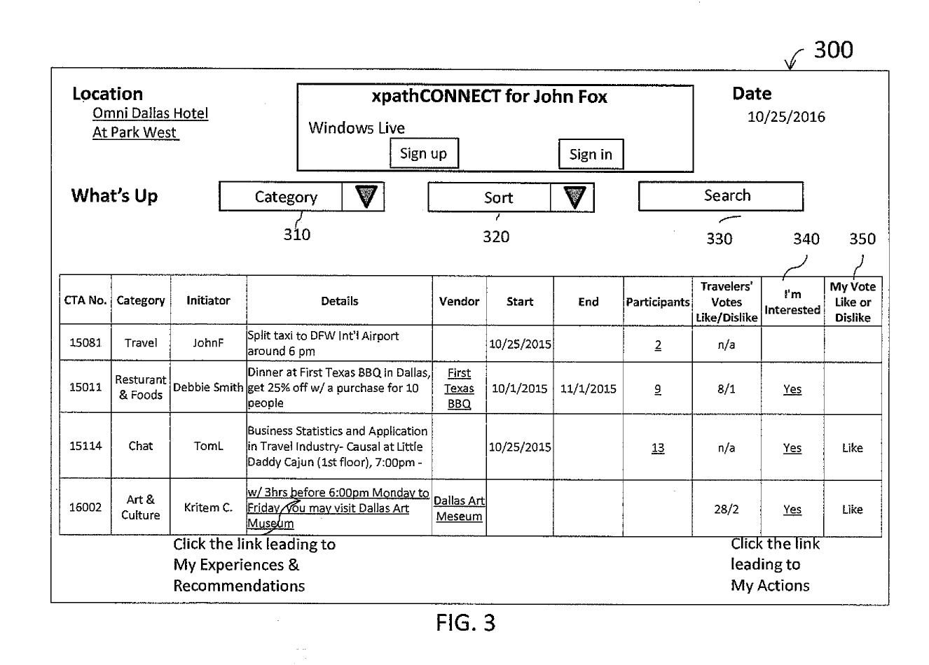

FIG. 3 illustrates the travelers' interests, needs and wants as shown in what's up 130 of a location during the timeframe that the subscriber specifies. The interests, needs and wants of the travelers at a location may be categorized as Foods, Chat, Art & Culture, Shopping, etc. The categorized interests, needs and wants may be updated regularly, which may serve as a call-to-action to solicit the participation of the current and future travelers. It may also serve as a call-to-action to the local business people who may provide their services, or customize their offers to meet the aggregated needs and wants of the travelers. An example of such a web page of a hotel or the like is shown in FIG. 3. A traveler may navigate by selecting the category 310, sort 320 by certain criteria such as date, or search 330 with a key word or phrase to find out his or her interested activities initialized by the other travelers. Each action or activity may include CTA no., Category, Initiator, Action details, Vendor Invited, Date Period, No. of participants, and No. of Likes or Dislikes on the activity from the previous travelers if applicable. The traveler may join an action by selecting “yes” under I'm interested 340 column. In addition, the traveler may express his or her opinion 350 as “Like” or “Dislike” as well post the activity, which may serve as a reference for other travelers or local business subscribers. If an activity is based on recommendations 131 or an offer from offers from local business 134, the activity details may include a source CTA no. from the corresponding tags. By clicking the CTA no, the details of the original action item may be presented to the traveler for review. If the vendor is invited, then the vendor may provide offer details or customize offers as needed for the participating travelers.

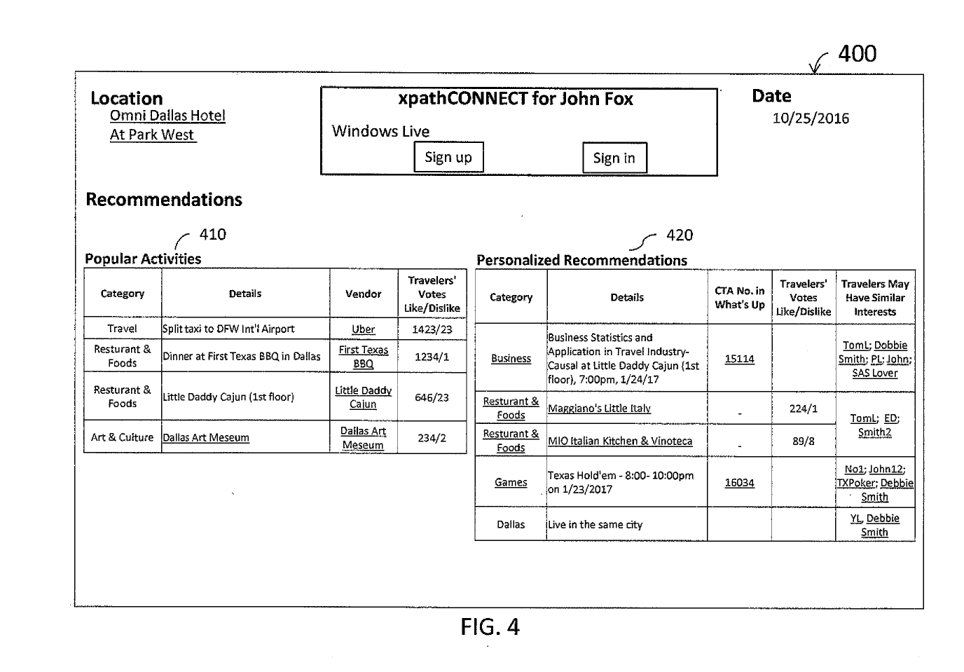

FIG. 4 illustrates the recommendations to a traveler at a location in the specified timeframe. The recommendations may include the popular activities and the personalized recommendations during the timeframe of the visiting. The personalized recommendations may not be presented until the subscriber provides more personal information in the categories of about me 202, file attached 203, and activities interested 204, etc. The detailed profile such as the activities interested, can help LCTN services provide better personalized recommendations to the traveler. FIG. 4 shows that John Fox from Dallas is interested in SAS, BA Application, Italian food and Poker. Additionally, he is interested in interacting with business travelers. Given the information, the LCTN services may identify the personalized recommendations for John that may include the relevant activities to meet his needs and wants, and the “lookalike” travelers with similar interests who not only happen to stay at the location at the same time as john but also express their willingness to meet other travelers.

Various data mining and statistical techniques may be used to generate personalized recommendations. The common techniques include but not limited to, text mining, affinity analysis, cluster analysis, predicting and prescriptive modeling, neural networking, etc. Text mining software may be used to retrieve the key words and-/or phrases from the traveler's profile, which may be stored in a database. The retrieved information may be used as inputs for various statistical analyses. For example, the travelers at a location may be grouped into segments for identifying “lookalike” travelers. With predictive and prescriptive analysis, each of the travelers may have a predicted probability score associated with each category of travelers' interests, which then may be used for personalized recommendations.

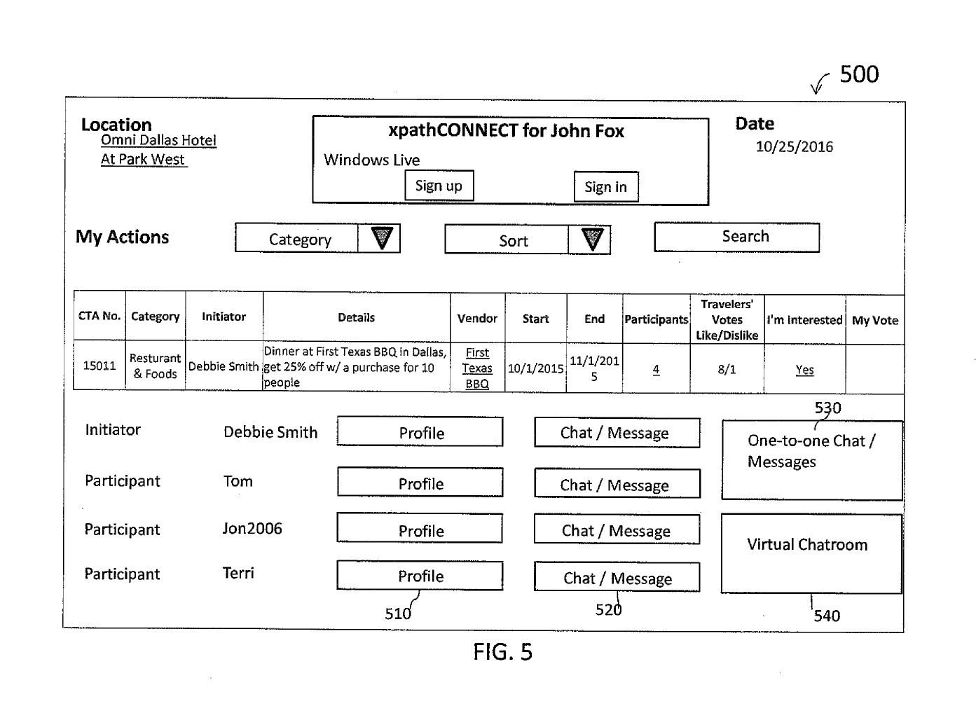

FIG. 5 illustrates all the activities interested or initialized by a traveler for easy tracking. My actions 500 may include the action items that the traveler expresses as his or her interests in what' up 130, and the action items that are initialized by the traveler.

LCTN may provide messaging services to facilitate “real life” meetings among all the subscribers. A subscriber may review the initiator and the participants' profiles 510 if permitted, may engage chats and -/or messages 520 through one-to-one chat/messages 530 and -/ or virtual chatroom 540. A subscriber who is logged into the virtual location may send messages to other subscribers via the LCTN. The messaging may include web-based messaging, SMS messaging (e.g., web-forum type messaging), peer-to-peer messaging, instant messaging, push messaging, or the like. A subscriber may also send messages to off-line subscribers in the form of an email-type message. The LCTN may include a web accessible “message box” to receive offline messages. A subscriber may establish privacy settings to control how the subscriber can be contacted.

A traveler may initialize an action by selecting a proper category 610 for CTA, and providing the details and-/or date period if applicable. If the action is based on recommendations 131, the action details may include the source CTA no. If the action is based on the offer 134 from a local business, the action details may include the source CTA no., and may invite the registered business for easy interactions.

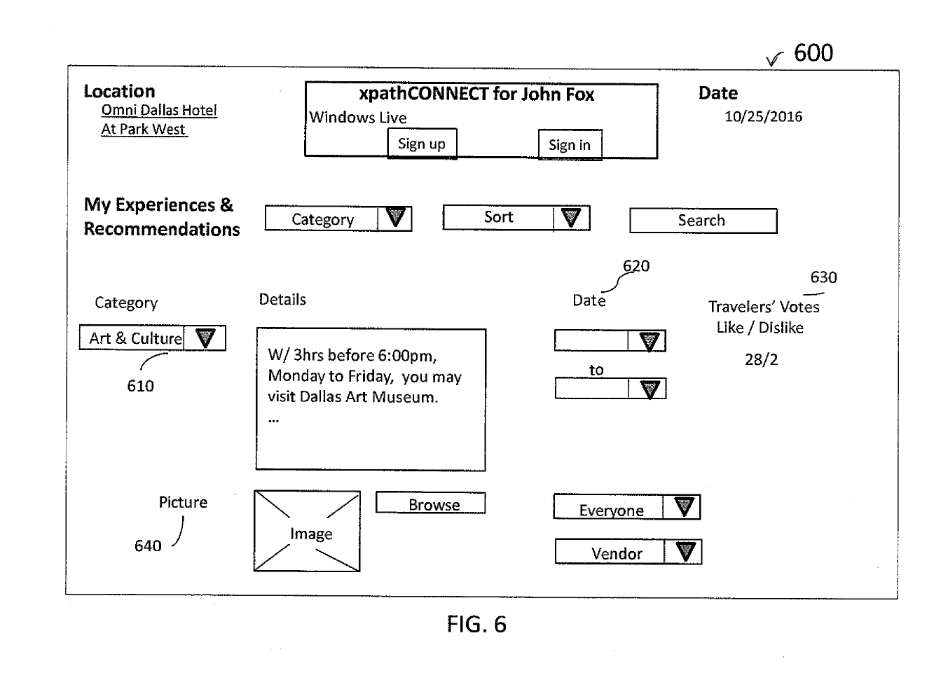

If an initialized action is approved by the LCTN administer, the action may be presented in what's up 130, and the responses from other travelers such as Travelers' votes (Like/Dislike) may be updated regularly as shown in FIGS. 3 and 6. Similarly, if an experience or recommendation is approved by the LCTN administer, the item may be presented in recommendations 131, and the responses from other travelers such as Travelers' votes (Like/Dislike) may be updated regularly as shown in FIG. 6.

The employees of a location in the LCTN may contribute experiences & recommendations as special subscribers. Similar to travelers, the employees may also have individual profiles for the network communications with indication of the employee at the location.

The best experience or recommendation may be rewarded by LCTN to encourage subscribers for providing insightful and creative experiences or recommendations. As such, the experiences and recommendations system may be improved and enriched overtime, which may become an important asset of a location.

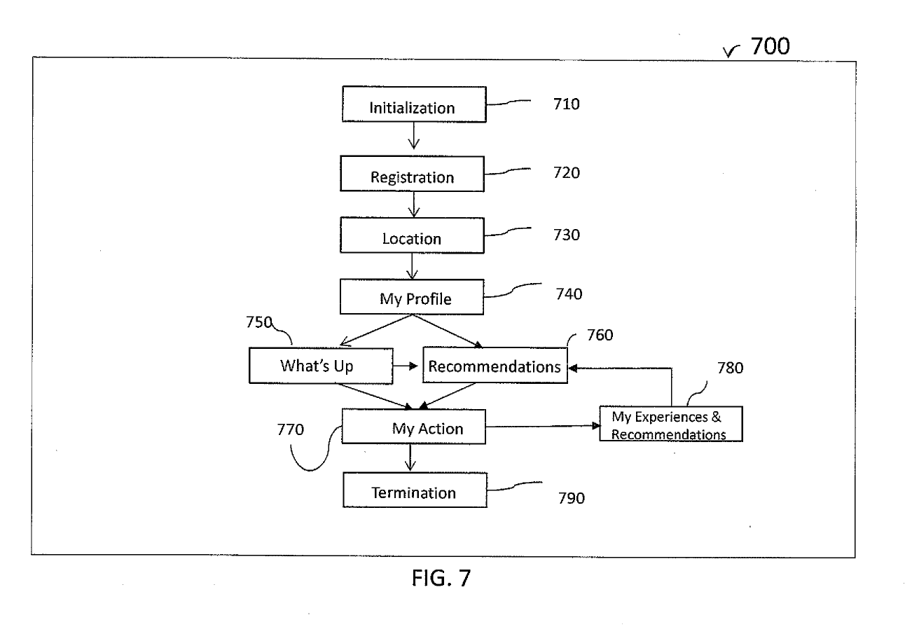

FIG. 7 illustrates a flow diagram of one embodiment of a method and system for providing Location Centric Travelers Network services. The method and system 700 may comprise one or more machine executable instructions stored on a non-transitory computer-readable storage medium. The instructions may be configured to cause a machine, such as a computing device, to perform steps of the method and system 700. In some embodiments, the instructions may be embodied as one or more distinct software modules or engines on the storage medium, such as a profile module, location database module, experiences & recommendations database modules, search engine, personalization engine, etc. One or more of the instructions and/or steps of the method and system 600 may interact with one or more hardware components, such as non-transitory computer-readable storage media, communications interfaces, or the like.

Accordingly, one or more of the steps of the method and system 700 may be tied to particular machine components.

At step 710, the method and system 700 may be initialized, which may comprise loading one or more instructions from a non-transitory computer-readable storage medium, accessing and/or initializing resources for the method and system 700 and the like.

At step 720, the method and system 700 may receive registration information from one or more of the LCSN subscribers. The registration information may include an invitation or other access credentials.

At step 730, the method and system 700 may receive location selection in which a subscriber may specify the dates interested.

At step 740, the method and system 700 may receive a traveler's profile information. The profile may include a name, contact information, and so on. The profile may further include an image, other descriptive information or social networks, such as accounts of LinkedIn, Facebook, Twitter, etc. The profile may also specify the traveler's willingness to share more personal information, which helps other subscribers determine if they want to be engaged with the subscriber in chatting, meeting, dining, and other activities.

At step 750, the method and system 700 may present the updated travelers' interests, needs and wants of a location to a subscriber. The list may facilitate interactions among the travelers and their interactions with a local business.

At step 760, the method and system 700 may present the popular activities of a location and the personalized recommendations to a subscriber, which may help the subscriber quickly identify the relevant activities and other travelers with similar interests at a location.

At step 770, the method and system 700 may enable a traveler to join the other subscribers to take actions, and-/or may initiate a new action that may be included in what's up 750 after approved by the LCTN administrator. In the new action initiated, a traveler may interact with and solicit a local business to provide new offers.

At step 780, the method and system 700 may enable a traveler to submit his or her experiences & recommendations that may be used in recommendations 760.

At step 790, the flow of the method and system 700 may be terminated until additional relevant information, messages, messaging requests, or the like are received.

It will also be readily understood that the order of the steps or actions of the methods and system described in connection with the embodiments disclosed may be changed as would be apparent to those skilled in the art. Thus, any order in the drawings or Detailed Description is for illustrative purposes only and is not meant to imply a required order, unless specified to require an order.

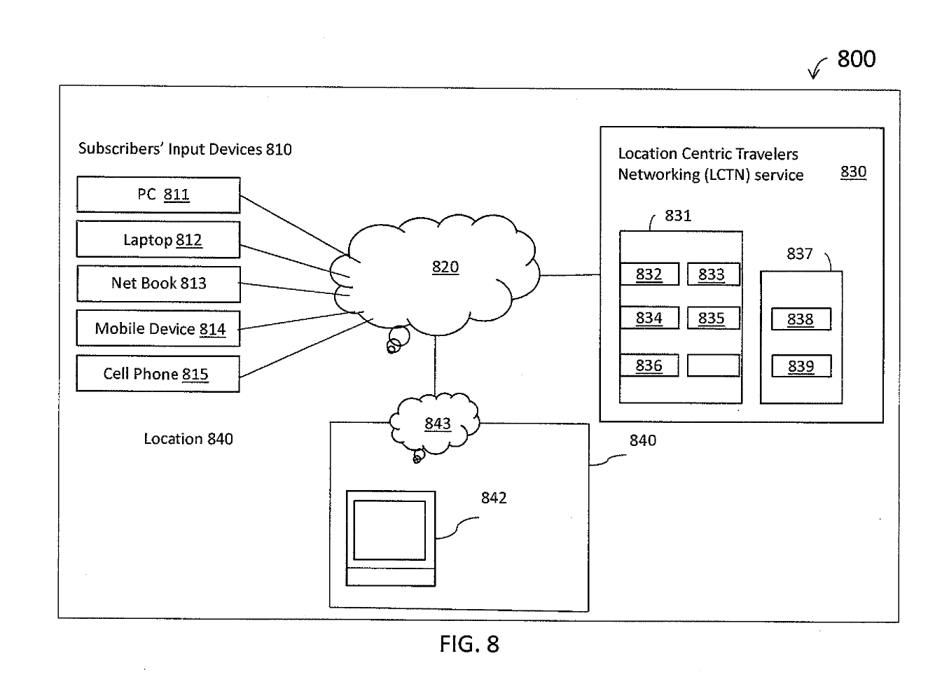

FIG. 8 illustrates an example of an environment in which subscribers communicate with the Location Centric Travelers Network services over the Internet or any other packed-based wide-area network. A plurality of subscribers of the LCTN 810 may communicate to a LCTN services 830 via a network 820.

The LCTN services 830 may typically include one or more physical computing devices 831 with one or more physical non-transitory computer-readable storage media 837 and /or databases as well as various processing engines.

A computing device 831 may include processing resources 832, communications interfaces 833, memory 834, non-transitory computer-readable storage media 835, and embodied one or more distinct software modules or engines such as a profile module, location database module, experiences & recommendations database modules, search engine, etc. A computing device 831 may include a server module 836. The server module 836 may be capable of providing web server (e.g., servicing HTTP and/or HTTPS requests from the subscribers 810, and so on) and /or performing other server functions, such as providing for file transfers, peer-to-peer communications (communications between the users 810), acting as a communications relay between subscribers 810, and so on.

The non-transitory computer-readable storage media 837 may be accessible to one or more computing devices 831.

The LCTN subscribers 810 may access the LCTN services 830 via the network 820 using any communication protocol and/or mechanism known in the art, and using any number of different types of devices including, but not limited to: a computing device (e.g., a portable computer, a tablet, a Netbook, a personal computer, a desktop computer, or the like), a phone, (e.g., a telephone, a smart phone, a cellular phone, a VOIP phone, or the like), a personal digital assistant (PDA), or the like. In the FIG. 8 example, subscriber 810 is shown accessing the LCSN services 830 using a PC 811, laptop 812, Netbook 813, Mobile device 814 and cell phone 815.

The LCTN may include one or more locations. As described in FIG. 8, a location 840 may have one or more location networks 843, and may refer to any place such as a hotel, an airport or the like where LCTN subscribers 810 may meet one another, and-/or obtain services desired. The location 840 may have one or more electronic messaging boards 842, from which the subscribers may obtain the updated travelers' activities at the location.

A location network administrator may manage the security and the LCTN services. A subscriber may be banned from the LCTN for inappropriate behavior (e.g., stalking other subscribers, violations of the location terms of services, or the like).

The above description provides specific details for a thorough understanding of the embodiments described herein. However, those of skill in the art will recognize that one or more of the specific details may be omitted, or other methods, components, or materials may be used. In some cases, operations are not shown or described in details. Furthermore, the described features, operations, or characteristics may be combined in any suitable manner in one or more embodiments.

We claim:

1. A non-transitory computer-readable storage medium configured for causing a computing device to perform a method for providing location centric travelers network services, comprising :
processing an message from applicants, said message comprising of registration requests;
granting subscription rights to qualified applicants;
receiving location selections from subscribers, said location selection comprising of the dates of visiting;
providing subscribers with updated travelers' activities at said location, said activities comprising of the details of said travelers' needs and wants while staying at said location;
receiving subscribers' profile information, said profile comprising of personal information;
providing subscribers with recommendations at said location, said recommendations comprising of the personalized recommendations;
enabling said subscribers for participating in said activities;
enabling said subscribers to interact among themselves for completing one or more said activities.

2. The method of claim 1, wherein said location centric travelers network comprising of one or more physical locations.

3. The method of claim 1, wherein said message receiving over the Internet or any wide-area network.

4. The method of claim 1, wherein said individual profile comprising of a plurality of fields populated by said traveler, and further comprising restricted access to each of said fields based on said traveler's preferences.

5. The method of claim 1, wherein said personalized recommendations comprising of an act of determining, for each traveler, an affinity score related to each category of said travelers' interests at a location based on at least one or more of a group of analytical information composing:
retrieving the key words and-/or phrases from a traveler's profile;
grouping said travelers into segments for identifying lookalike travelers;
using said retrieved information from said travelers' profiles as inputs for determining affinity scores.

6. The method of claim 1, further comprising of an act of allowing said travelers to interact and solicit businesses for providing new offers to said travelers.

7. The method of claim 1, further comprising of an act of allowing said travelers to post opinions on said activities, experiences or recommendations post stay at said location.

8. The method of claim 1, further comprising of an act of rewarding said travelers for the best recommendations and said business for the best services provided.

9. The method of claim 1, further comprising one or more electronic messaging boards for updating subscribers' activities at said locations.

10. A system for providing location centric travelers network services, comprising:
a location centric service including a computer distribution system having at least one processor and a memory.
an interface adopted to receive an input from a device defining a request of subscribing to said services at least at one location.
a component of presenting qualified subscribers with updated travelers' activities at said location, said activities comprising of the details of said travelers' needs and wants while staying at said location;
a component of determining personalized recommendations based on provided personal information;
a component of enabling said subscribers to interact with each other and interact as an individual or as a group with local businesses

11. The system of claim 10, wherein said location centric service comprising one or more physical computing devices with one or more physical non-transitory computer-readable storage media.

12. The system of claim 11, wherein said computing device embodied one or more distinct software modules or engines.

13. The system of claim 10, wherein said input receiving over the Internet or any wide-area network.

14. The system of claim 10, wherein said subscribers accessing said services via network using any communication protocol and/or mechanism, and using any number of different types of devices.

15. The system of claim 10, wherein said non-transitory computer-readable storage media accessible to one or more said computing devices.

16. The system of claim 10, wherein said personalized recommendations comprising of an act of determining, for each traveler, an affinity score related to each category of said travelers' interests at a location based on at least one or more of a group of analytical information composing:
retrieving the key words and-/or phrases from a traveler's profile;
grouping said travelers into segments for identifying lookalike travelers;
using said retrieved information from said travelers' profiles as inputs for determining affinity scores.

17. The system of claim 10, further comprising one or more electronic messaging boards for updating subscribers' activities at said locations.

18. A computer-implemented method for providing location centric travelers network services to a plurality of subscribers, comprising:
a computing device configured for registering a plurality of locations in location centric travelers network, each location being associated with a respective physical location;
said computing device configured for processing messages from subscribers, said messages comprising of registration requests;
said computing device configured for granting subscription rights to qualified applicants;
said computing device configured for receiving location selections from said subscribers, said location selection comprising of the dates of visiting;
said computing device configured for providing said subscribers with updated travelers' activities at said location, said activities comprising of the details of said subscribers' needs and wants while staying at said location;
said computing device configured for receiving subscribers' profile information, said profile comprising of personal information;
said computing device configured for providing subscribers with recommendations at said location, said recommendations comprising of the personalized recommendations;
said computing device configured for enabling said subscribers to participate in said activities;
said computing device configured for enabling said subscribers to interact among themselves for completing one or more said activities.

19. The method of claim 18, further comprising one or more electronic messaging boards for updating subscribers' activities at said locations.

20. The method of claim 18, wherein said personalized recommendations comprising of an act of determining, for each traveler, an affinity score related to each interest category of the travelers at a location, by using predictive and prescriptive techniques.
